(19) United States
(12) Patent Application Publication
(10) Pub. No.: US 2004/0155393 A1
(43) Pub. Date: Aug. 12, 2004

(54) Magnetic holding device

(76) Inventor: Glen L. Wright, Arcadia NSW (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/475,053

(22) PCT Filed: Apr. 19, 2002
(86) PCT No.: PCT/AU02/00496

(30) Foreign Application Priority Data
Apr. 20, 2001 (AU) PR4515

(51) Int. Cl. B25B 11/00; B21B 13/22

(52) U.S. Cl. 269/8; 29/527.1; 29/428

(57) ABSTRACT

A magnetic holding device (10) and a method for the manufacture thereof. The device (10) is used in the field of graphic arts such as foil stamping. The device (10) secures a steel back polymer plate to a heating element, for the purposes of transferring thin metal foil or leaf to paper, card, plastics material or similar media. The device (10) has a space locations a plurality of magnets (13) embedded in a body (14) of the device (10). The magnets (13) are preferably Samarium Cobalt Disk magnets and are held within the body (14) by means of an adhesive such as Loctite 620(®*).

### TECHNICAL FIELD

The present invention relates to magnetic holding devices such as that disclosed in Australian Patent Application 17618/95 employed in the field of graphic arts, such as foil stamping.

### BACKGROUND OF THE INVENTION

The above-mentioned Australian patent application discloses a holding device which secures a steel back photopolymer plate to a heating element, for the purposes of transferring thin metal foil or leaf to paper card, plastics material or similar media.

Use of the above-mentioned holding device demonstrated a number of shortcomings including the magnets employed progressively loosing their magnetic strength. A further problem was securing the magnets to the body of the device. Various methods employed were found to be unsuitable when subjected to continuous heat and pressure. A more significant problem was oxidation of the surface of the device after machining. This oxidation led to the surface of the magnets being gradually eroded until they were below the surface of the device. This resulted in uneven surface dimensions which gave poor stamping results.

Described in International Application PCT/AU00/00428 is a modification of the above-described magnetic holding device. This previously known device had a number of disadvantages including reduction of the forces applied to the steel-backed polymer plate believed to result from the electrolitic deposit of nickel on the device and the spacing of magnets from the plate.

### OBJECT OF THE INVENTION

It is the object of the present invention to overcome or substantially ameliorate at least one of the above disadvantages.

### SUMMARY OF THE INVENTION

There is disclosed herein a magnetic holding device to secure a steel backed polymer plate to a foil stamping heating element, said device having:

a body having a body surface to engage the plate;

a plurality of magnets embedded in the body so as to each have a magnetic surface substantially co-planar with respect to said body surface, the magnets being provided to urge the plate into contact with the body and magnetic surface, said magnets being disshaped and having a diameter of approximately 6 millimetres; and

a layer of nickel covering said body surface and the magnetic surface.

Preferably, said body is generally planar and said body surface is generally planar.

In an alternative arrangement said body is generally arcuate and said body surface is generally arcuate. In a specific form the body is circular in transverse cross-section and said body surface is circular.

Preferably the layer of nickel is between 0.1 millimetres and 0.025 millimetres.

Preferably the magnets are secured within the body by Loctite 620 (registered trade mark).

Preferably the magnets are Samarium Cobalt Disc Magnets.

There is further disclosed herein a method to produce the above-described attachment device, said method including the steps of:

providing said body with apertures to receive said magnets, said apertures being generally cylindrical and extending through said body;

placing an adhesive in the apertures;

placing the magnets in the apertures so as to be secured to the body with the aid of the adhesive so that the magnets have an end surface generally coplanar with said body surface;

nickel plating the body and magnets so that the layer of nickel covers said body and magnetic surfaces.

Preferably the body provided is heat annealed to relieve surface tension prior to machining.

Preferably the body is engraver's brass.

Preferably the nickel layer is about 0.05 millimetres in thickness.

Preferably the nickel layer is 0.1 to 0.025 millimetres in thickness.

### BRIEF DESCRIPTION OF THE DRAWINGS

A preferred form of the present invention will now be described by way of example with reference to the accompanying drawings wherein

FIG. 1 is a schematic perspective view of a magnetic holding device;

FIG. 2 is a schematic section side elevation of a portion of the device of FIG. 1;

FIG. 3 is a schematic plan view of a lifting mechanism to be employed with the device of FIG. 1; and

FIG. 4 is a schematic side elevation of the mechanism of FIG. 3.

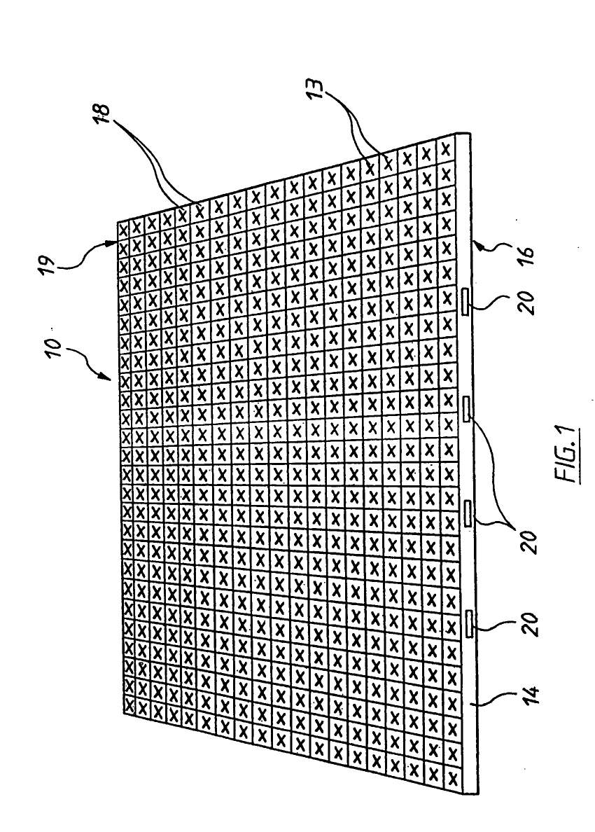

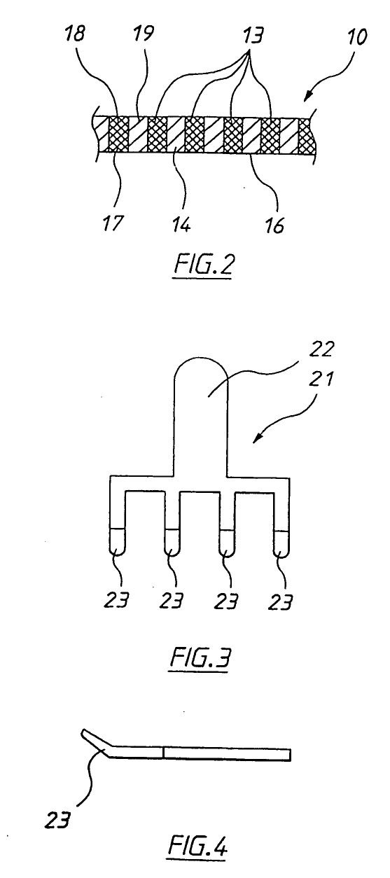

### DETAILED DESCRIPTION OF THE PREFERRED EMBODIMENT

In the accompanying drawings there is schematically depicted a magnetic holding device 10. In this embodiment the device 10 is approximately the size of an A4 sheet of paper.

More particularly, there is shown in the attached drawings a portion of a holding device 10. The device 10 has at spaced locations a plurality of magnets 13 embedded in the body 14.

The body 14 is formed of engraver's brass that when initially provided has been heat annealed to relieve surface tension and is about 4.85 millimetres thick. The body 14 is drilled to provide a pilot hole to facilitate the drilling of holes through the body 14. The holes receive the magnets 13. The magnets 13 are about 6 millimetres in diameter. As mentioned previously, the magnets 13 are preferably Samarium Cobalt Disc magnets. However, to ensure securing of the magnets 13 within the body 14, there is provided in each hole a layer of adhesive (Loctite 620 (registered trade mark)) 15. The layer 15 generally surrounds the magnets 15 so as to compensate for imperfections in the magnets 15 and formation of the holes within which they are located. The magnets have end faces 17 and 18 substantially coplanar with the surface 16 and 19. The body 14 and magnets 13 are also nickel coated so that a layer of nickel 20 overlays the surfaces 17 and 19, or at least the surface 19. Preferably the layer 20 has a thickness of about 0.05 millimeters. In a further preferred form the layer has a thickness of 0.1 to 0.0025 millimeters.

The nickel layer 20 is not electrostatically applied. The layer 20 is applied by submersing the device 10 in a bath, such as set out in the following table:

Ingredient of EN Bath

| Ingredient (g/L) and Control | Volume |
|---|---|
| NiSO.7HO | 30 |
| NaHPO.HO | 15-25 |
| NaCHO | 15 |
| NaCHO | 15 |
| CHO.6HO | 5 |
| CH (NH) COOH | 5-15 |
| pH | 3.5-5.4 |
| Temperature (° C.) | 85-95 |
| Application speed (υm/h) | 12-15 |
| Density ratio (dm²/L) | 1 |
| Mid-high phosphorus (%) | 7-11 |

The above-described preferred embodiment of the present invention exhibits a number of advantages including greater cycle life. Still further, the Samarium Cobalt Disc Magnets have a greater operating temperature (250° C. to 350° C.) which provides the magnets with a prolonged life. The use of the above-mentioned Loctite also enables the device to stand up to continuous heat and pressure typical of the environment of the present invention. Still further, the engraver's brass has been found to be easier to machine while providing superior toughness and heat conductivity while also resisting corrosion.

Engraver's brass is 70/30 Arsenical Brass Alloy 259. As an alternative brass alloy 377 can be used.

The Samarium Cobalt magnets are sintered, with their composition being about 35% Samarium, 60% Cobalt, the balance being Fe and Cu.

It should further be appreciated that the above preferred embodiment is also useable with copper and brass steel backed plates and steel plates.

In respect of the above referred embodiment, the body 14 is generally planar (flat). Accordingly, the surfaces 17 and 18 are also flat. In an alternative arrangement the body 14 could be generally cylindrical so as to have a generally circular transverse cross-section. In such an instance, the surfaces 17 and 17 and 18 would be cylindrical.

When manufacturing the above-described device 10, the body 10 would be placed on a steel plate and the magnets 13 placed in the holes. The magnets 13 would then be attracted to the supporting plate and therefore have an end face flush with the surface 19 that would be abutting the supporting plate.

The device 10 is provided with a plurality of slots 20 that are engaged by a tool 21. The tool 21 has a handle 22 from which there extends a plurality of arms 23 which engage within the slots 20. The arms 23 are shaped so that upon a force being applied to the handle 22 the arms 23 aid in lifting the device 10.

The magnets 13 are spaced (centre-to-centre) by 7 mm to 56 mm. In a further preferred form the surface 19 is roughened by sand blasters, photo-etching, engraving etc. This enhances secure contact with the photopolymer plate. This is particularly beneficial in cylinder (linear impression) foil stamping machines.

The claims defining the invention are as follows:

1. A magnetic holding device to secure a steel backed polymer plate to a foil stamping heating element, said device having:
a body having a body surface to engage the plate;
a plurality of magnets embedded in the body so as to each have a magnetic surface substantially co-planar with respect to said body surface, the magnets being provided to urge the plate into contact with the body and magnetic surface, said magnets being disshaped and having a diameter of approximately 6 millimetres; and
a layer of nickel covering said body surface and the magnetic surface.

2. The device of claim 1 wherein said body is generally planar and said body surface is generally planar.

3. The device of claim 1 wherein said body is generally arcuate and said body surface is generally arcuate. In a specific form the body is circular in transverse cross-section and said body surface is circular.

4. The device of claim 1, 2 or 3 wherein the layer of nickel is between 0.1 millimetres and 0.025 millimetres.

5. The device of claim 1 to 4 wherein the magnets are secured within the body by Loctite 620 (registered trade mark).

6. The device of claim 1 to 5 wherein the magnets are Samarium Cobalt Disc Magnets.

7. A method to produce the device of said claim 1 to 7 wherein said method including the steps of:
providing said body with apertures to receive said magnets, said apertures being generally cylindrical and extending through said body;
placing an adhesive in the apertures;
placing the magnets in the apertures so as to be secured to the body with the aid of the adhesive so that the magnets have an end surface generally coplanar with said body surface;
nickel plating the body and magnets so that the layer of nickel covers said body and magnetic surfaces.

8. The method of claim 7 wherein the body provided is heat annealed to relieve surface tension prior to machining.

9. The method of claim 7 or 8 wherein the body is engraver's brass.

10. The method of claim 7, 8 or 9 wherein the nickel layer is about 0.05 millimetres in thickness.

11. The method of claim 7, 8 or 9 wherein the nickel layer is 0.1 to 0.025 millimetres in thickness.

12. A magnetic holding device substantially as hereinbefore described with reference to the accompanying drawing.

13. A method of producing a magnetic holding device substantially as hereinbefore described with reference to the accompanying drawing.
